(19) United States
(12) Patent Application Publication
(10) Pub. No.: US 2014/0034047 A1
(43) Pub. Date: Feb. 6, 2014

(54) PROCESSES AND APPARATUS FOR LIGNIN SEPARATION IN BIOREFINERIES

(71) Applicant: API Intellectual Property Holdings, LLC, Atlanta, GA (US)

(72) Inventors: Theodora RETSINA, Atlanta, GA (US); Vesa PYLKKANEN, Atlanta, GA (US); Kimberly NELSON, Atlanta, GA (US); Mark SZCZEPANIK, Alpena, MI (US)

(73) Assignee: API Intellectual Property Holdings, LLC, Atlanta, GA (US)

(21) Appl. No.: 13/959,705

(22) Filed: Aug. 5, 2013

Related U.S. Application Data
(60) Provisional application No. 61/679,793, filed on Aug. 6, 2012.

(51) Int. Cl. C08B 1/00

(52) U.S. Cl. CPC C08B 1/00
USPC 127/37

(57) ABSTRACT

The present invention generally provides methods of improving lignin separation during lignocellulosic biorefining, comprising the steps of (i) catalyzing fractionation or hydrolysis with an acid to release sugars into an acidified solution containing lignin, (ii) neutralizing the acidified solution with a base to form a salt in a neutralized solution; (iii) in a separation unit, separating the salt and the lignin, each in free or combined form, from the neutralized solution; and then (iv) recycling a portion of the salt and optionally a portion of the lignin to step (i) to combine, physically or chemically, with the lignin, to improve lignin separation in the separation unit. In certain embodiments, the acid is a sulfur-containing acid and the base is lime, forming gypsum which is then recycled, in part, to the hydrolysis reactor.

### PRIORITY DATA

This patent application is a non-provisional application claiming priority to U.S. Provisional Patent App. No. 61/679,793 filed Aug. 6, 2012, which is hereby incorporated by reference herein.

### FIELD OF THE INVENTION

The present invention generally relates to improved processes for recovering fermentable sugars from lignocellulosic biomass.

### BACKGROUND OF THE INVENTION

Biomass refining (or biorefining), which separates cellulose, hemicellulose, and lignin from biomass feedstocks, is becoming more prevalent in industrial plants. Cellulose fibers and sugars, and hemicellulose sugars, are being used by many companies for chemical and fuel production. Indeed, we now are observing the commercialization of integrated biorefineries that are capable of processing incoming biomass much the same as petroleum refineries now process crude oil. Underutilized lignocellulosic biomass feedstocks have the potential to be much cheaper than petroleum, on a carbon basis, as well as much better from an environmental life-cycle standpoint.

One of the biggest and well-known challenges in many biorefineries is dealing with lignin. Lignin is a major component of biomass. It is typically between 15-35 wt % (dry basis) of the biomass material. Lignin has good fuel value, similar to some types of coal.

The word lignin is derived from the Latin word “lignum” meaning wood. Lignin is a natural polymer and is an essential part of wood and other forms of cellulosic biomass, including agricultural crop residues such as sugarcane bagasse. Lignin performs multiple functions that are essential to the life of the plant, including transport of nutrition and durability of the biomass. Lignin imparts rigidity to the cell walls and acts as a binder, creating a flexible composite cellulose—hemicellulose—lignin material that is outstandingly resistant to impact, compression, and bending.

After polysaccharides (polymers of sugar), lignin is the most abundant organic polymer in the plant world. Lignin is a very complex natural polymer with many random couplings, and therefore lignin has no exact chemical structure. The molecular structure of lignin consists primarily of carbon ring structures (benzene rings with methoxyl, hydroxyl, and propyl groups.

Various processes can be used to remove and isolate lignin from biomass. Each process, however, produces material of different composition and properties. Generally there are four important factors to take into account when working with lignin:
1. Source of the lignin.
2. Method used to remove lignin from the biomass.
3. Method(s) used to purify the lignin.
4. Nature of the chemical modification of the lignin after isolation.
   These factors influence the properties of the lignin. Important properties of lignin formulations include molecular weight, chemical composition, and the type and distribution of chemical functional groups.

Separation and recovery of lignin is quite difficult. It is possible to break the lignin—cellulose—hemicellulose matrix and recover the lignin through a variety of treatments on the lignocellulosic material. However, known lignin recovery methods generally have one or more important commercial-scale limitations. Lignin purification from biomass is a classic chemical-engineering problem with complex chemistries and transport phenomena, criticality of reactor design and scale-up, serious analytical challenges, and many practical issues arising from lignin's propensity to stick to equipment and piping.

Lignin can be difficult to process in biorefineries because it has a tendency to deposit on solid surfaces and cause plugging. Although lignin handling has always been known to be a challenge, there remains a need in the art for ways to either avoid lignin precipitation or to deal with it after it occurs. Other difficulties are caused by downstream fermentation inhibition caused by lignin, as well as lignin fragments and derivatives (e.g., phenolics, acids, and other compounds).

Lignin separations challenges appear to be particularly troubling problem for acidic pretreatments of biomass or biomass-derived liquors. For example, in van Heiningen et al., “Which fractionation process can overcome the techno-economic hurdles of a lignocellulosic biorefinery,” Proceedings of the AIChE Annual Meeting, Minneapolis, Min. (2011), it is cautioned that “an operating problem which has mostly been overlooked for acidic pretreatment is formation and precipitation of sticky lignin on reactor walls and piping.” The lack of R&D attention to this problem is stated to be that it only “becomes apparent in continuous larger scale operation after one to two week operation.”

In view of the aforementioned needs in the art, improvements are clearly needed to avoid, or deal with, lignin precipitation during acidic hydrolysis of biomass and/or biomass hydrolysates (such as hemicellulose-containing liquid extracts).

### SUMMARY OF THE INVENTION

The present invention addresses the aforementioned needs in the art.

In some variations, the invention provides a process for producing fermentable hemicellulose sugars from lignocellulosic biomass, the process comprising:
(a) providing a feedstock comprising lignocellulosic biomass;
(b) in an extraction unit, extracting the feedstock under effective extraction conditions to produce an extract liquor containing hemicellulosic oligomers, cellulose-rich solids, and lignin;
(c) substantially removing the cellulose-rich solids from the extract liquor;
(d) in a hydrolysis reactor, hydrolyzing the hemicellulosic oligomers contained in the extract liquor, in the presence of a hydrolysis catalyst, to produce fermentable hemicellulosic sugars;
(e) introducing a solid additive to the hydrolysis reactor, wherein the solid additive combines with at least a portion of the lignin;

(f) separating a mixture comprising the lignin and the solid additive, each in free or combined form, from the fermentable hemicellulosic sugars; and
(g) recovering the fermentable hemicellulosic sugars.

In some embodiments, effective extraction conditions include contacting the lignocellulosic biomass with steam and/or hot water. In some embodiments, the hydrolysis catalyst is an acid catalyst, such as a hydrolysis catalyst selected from the group consisting of sulfuric acid, sulfurous acid, sulfur dioxide, and combinations thereof

The solid additive has a density of at least 1.5 g/cm³ or at least 2.0 g/cm³, in some embodiments. The solid additive may be introduced to the hydrolysis reactor as a dry powder, a slurry, or partially or fully dissolved in a solution. In some embodiments, the solid additive is present in the hydrolysis reactor at a concentration of at least 0.1 g/L, 1 g/L, 10 g/L, or more.

In some embodiments, the solid additive contains sulfur, such as a sulfate salt. At least a portion of the sulfur may reacts with the lignin to generate sulfonated lignin.

The solid additive may be selected from the group consisting of metal sulfates, metal sulfate hydrates, metal sulfate derivatives, ammonium sulfate, ammonium sulfate derivatives, native lignin, acid-condensed lignin, sulfonated lignin, lignin derivatives, and combinations thereof

In some embodiments, the solid additive is selected from the group consisting of anhydrite, calcium sulfate hemihydrate, calcium sulfate dihydrate (gypsum), and combinations thereof The solid additive may comprise or consist essentially of gypsum. The solid additive may comprise or consist essentially of gypsum and lignin. The gypsum may be recycled gypsum that is generated following step (f). In some embodiments, the lignin is recycled lignin that is removed following step (f).

The solid additive may alternatively, or additionally, be selected from the group consisting of minerals, diatomaceous earth, silica, alumina, ash, zeolites, metal alums, ammonium alum, dust, cellulose, nanocellulose, sawdust, agricultural residue pith, biomass fines, and combinations thereof

In some embodiments, at least a portion of the solid additive combines, chemically or physically, with the lignin to form a lignin—additive complex that has a higher density than the density of the lignin. In some embodiments, at least a portion of the solid additive combines, chemically or physically, with the lignin to form a lignin—additive complex that has a higher settling rate than that of the lignin. In some embodiments, at least a portion of the solid additive combines, chemically or physically, with the lignin to form a lignin—additive complex that has a higher viscosity than that of the lignin. In some embodiments, at least a portion of the solid additive combines, chemically or physically, with the lignin to form a lignin—additive complex that has a higher ratio of density to viscosity compared to the lignin. In some embodiments, at least a portion of the solid additive combines, chemically or physically, with the lignin to form a lignin—additive complex that has reduced tackiness compared to the lignin.

Step (e) may be performed prior to step (d). The process may further include recovering and recycling at least a portion of the hydrolysis catalyst. The process may further include recovering and recycling at least a portion of the solid additive.

Certain embodiments provide a process for producing fermentable hemicellulose sugars from lignocellulosic biomass, the process comprising:
(a) providing a feedstock comprising lignocellulosic biomass;
(b) in an extraction unit, extracting the feedstock under effective extraction conditions with steam or hot water to produce an extract liquor containing hemicellulosic oligomers, cellulose-rich solids, and lignin;
(c) substantially removing the cellulose-rich solids from the extract liquor;
(d) in a hydrolysis reactor, hydrolyzing the hemicellulosic oligomers contained in the extract liquor, in the presence of an acid hydrolysis catalyst, to produce fermentable hemicellulosic sugars;
(e) introducing gypsum to the hydrolysis reactor, wherein the gypsum combines with at least a portion of the lignin;
(f) separating a mixture comprising the lignin and the gypsum, each in free or combined form, from the fermentable hemicellulosic sugars;
(g) neutralizing an acidic solution of the fermentable hemicellulosic sugars with lime, thereby generating produced gypsum;
(h) recovering the fermentable hemicellulosic sugars; and
(i) recycling at least a portion of the produced gypsum to step (e).

Other embodiments provide a process for producing fermentable hemicellulose sugars from lignocellulosic biomass, the process comprising:
(a) providing a feedstock comprising lignocellulosic biomass;
(b) in an extraction unit, extracting the feedstock under effective extraction conditions to produce an extract liquor containing hemicellulosic oligomers, cellulose-rich solids, and lignin;
(c) substantially removing the cellulose-rich solids from the extract liquor;
(d) in a hydrolysis reactor, hydrolyzing the hemicellulosic oligomers contained in the extract liquor, in the presence of a hydrolysis catalyst, to produce fermentable hemicellulosic sugars;
(e) introducing an additive precursor or precursors to the hydrolysis reactor, wherein the additive precursor or precursors react in situ to produce an additive that combines with at least a portion of the lignin;
(f) separating a mixture comprising the lignin and the additive, each in free or combined form, from the fermentable hemicellulosic sugars; and
(g) recovering the fermentable hemicellulosic sugars.

For example, the additive precursor or precursors may comprise lime, so that the additive comprises gypsum.

Still other variations provide a process for producing sugars from lignocellulosic biomass, the process comprising:
(a) providing a lignocellulosic biomass feedstock comprising cellulose, hemicellulose, and lignin;
(b) in a pretreatment reactor, pretreating the feedstock in a liquid solution including a hydrolysis catalyst to hydrolyze the hemicellulose into hemicellulosic sugars and to release at least a portion of the lignin into the solution;
(c) introducing a solid additive to the pretreatment reactor, wherein the solid additive combines with at least a portion of the lignin in the solution, prior to step (d) and optionally during or prior to step (b);
(d) optionally removing a mixture comprising the lignin and the solid additive, each in free or combined form, from the solution;
(e) recovering the hemicellulosic sugars; and
(f) optionally separating cellulose-rich solids comprising the cellulose from the solution, hydrolyzing the cellulose with enzymes or an acid to produce glucose, and recovering the glucose.

Pretreating may include contacting the feedstock with steam and/or hot water. The hydrolysis catalyst may be an acid catalyst, such as a hydrolysis catalyst selected from the group consisting of sulfuric acid, sulfurous acid, sulfur dioxide, and combinations thereof The hydrolysis catalyst and the solid additive may each be recovered and recycled.

The solid additive may selected from the group consisting of metal sulfates, metal sulfate hydrates, metal sulfate derivatives, ammonium sulfate, ammonium sulfate derivatives, native lignin, acid-condensed lignin, sulfonated lignin, lignin derivatives, minerals, diatomaceous earth, silica, alumina, ash, activated carbon, zeolites, metal alums, ammonium alum, dust, cellulose, nanocellulose, sawdust, agricultural residue pith, and biomass fines, in any combination of fresh or recycled forms of one or multiple components thereof

Certain embodiments provide a process for producing sugars from lignocellulosic biomass, the process comprising:
(a) providing a lignocellulosic biomass feedstock comprising cellulose, hemicellulose, and lignin;
(b) in a pretreatment reactor, pretreating the feedstock in a liquid solution including an acid hydrolysis catalyst to hydrolyze the hemicellulose into hemicellulosic sugars and to release at least a portion of the lignin into the solution;
(c) introducing gypsum to the pretreatment reactor, wherein the gypsum combines with at least a portion of the lignin in the solution, prior to step (d);
(d) optionally removing a mixture comprising the lignin and the gypsum, each in free or combined form, from the solution;
(e) neutralizing an acidic solution of the hemicellulosic sugars with lime, thereby generating produced gypsum;
(f) recovering the hemicellulosic sugars;
(g) recycling at least a portion of the produced gypsum to step (e); and
(h) optionally separating cellulose-rich solids comprising the cellulose from the solution of step (b), hydrolyzing the cellulose with enzymes or an acid to produce glucose, and recovering the glucose.

The present invention generally provides methods of improving lignin separation during lignocellulosic biorefining, the method comprising the steps of (i) catalyzing fractionation or hydrolysis with an acid to release sugars into an acidified solution containing lignin, (ii) neutralizing the acidified solution with a base to form a salt in a neutralized solution; (iii) in a separation unit, separating the salt and the lignin, each in free or combined form, from the neutralized solution; and then (iv) recycling a portion of the salt and optionally a portion of the lignin to step (i) to combine, physically or chemically, with the lignin, to improve lignin separation in the separation unit.

The separation unit may be selected from the group consisting of a filter, a membrane, a decanter, a clarifier, a hydrocyclone, and a centrifuge, for example. The salt may be selected from the group consisting of metal sulfates, metal sulfate hydrates, metal sulfate derivatives, ammonium sulfate, ammonium sulfate derivatives, and combinations thereof In some embodiments, the salt is selected from the group consisting of anhydrite, calcium sulfate hemihydrate, calcium sulfate dihydrate (gypsum), and combinations thereof In certain embodiments, the salt comprises gypsum, or is gypsum.

A method of improving lignin separation during lignocellulosic biorefining, in specific embodiments, comprises the steps of (i) catalyzing fractionation or hydrolysis with a sulfur-containing acid and/or sulfur dioxide to release sugars and lignin into an acidified solution, (ii) neutralizing the acidified solution with lime to form gypsum in a neutralized solution; (iii) in a separation unit, separating the gypsum and the lignin, individually or in combination, from the neutralized solution; and then (iv) recycling a portion of the gypsum and optionally a portion of the lignin to step (i) to combine, physically or chemically, with the lignin released in step (i), to improve lignin separation in the separation unit in step (iii).

The present invention provides apparatus to carry out the recited methods. The present invention also provides systems configured for the disclosed processes or methods. Finally, this invention provides products produced by any of the recited processes or methods. Such products include cellulosic ethanol or butanol; cellulose-rich solids for combustion, pellets, or other uses; and lignin for combustion or as a chemical feedstock.

### BRIEF DESCRIPTION OF THE FIGURE

FIG. 1 is a simplified block-flow diagram depicting the process of some embodiments of the present invention.

### DETAILED DESCRIPTION OF EMBODIMENTS OF THE INVENTION

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with any accompanying drawings.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs. All composition numbers and ranges based on percentages are weight percentages, unless indicated otherwise. All ranges of numbers or conditions are meant to encompass any specific value contained within the range, rounded to any suitable decimal point.

Unless otherwise indicated, all numbers expressing reaction conditions, stoichiometries, concentrations of components, and so forth used in the specification and claims are to be understood as being modified in all instances by the term “about.”

Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”

All references to “lignin” herein shall not be construed as limiting to any particular type of lignin or process to produce lignin. For example, in some embodiments, lignin refers to “Hydrolysis Lignin,” a water-insoluble product produced by the strong acid hydrolysis of woody material to produce sugars. The resulting lignin is altered structurally and contains sugar degradation products, wood extractives, and inorganic compounds.

In various embodiments, lignin refers to Brauns Lignin (obtained by the solvent extraction of wood meal); Cellulolytic Enzyme Lignin (isolated by cellulolytic enzyme treatment of finely ground wood meal followed by solvent extraction); Dioxane Acidolysis Lignin (isolated by the treatment of woody material with dioxane/dilute HCl); Milled Wood Lignin (isolated by solvent extraction and purification of finely ground wood meal; also known as Bjorkman Lignin); Klason Lignin (isolated through the strong acid degradation of woody materials); Periodate Lignin (isolated through successive treatments of woody material with sodium periodate followed by boiling water); Kraft Lignin (generated through Kraft pulping, wherein water-insoluble lignin is made from woody material in reaction with NaOH and Na₂S at temperatures of 155-175° C.; Lignosulfonates from Acid Sulfite Pulping (water-soluble lignin obtained by reacting woody material with sulfur dioxide and a metal bisulfite at pH 1-2 and a temperature between 125-145° C.); Lignosulfonates from Bisulfite Pulping (water-soluble lignin obtained by reacting woody material with a metal bisulfite salt at a pH of 3-5 at 150-175° C.; Lignosulfonates from Neutral Sulfite Semi Chemical Process (water-soluble lignin obtained by reacting woody material with salts of bisulfite/sulfite at pH 6-9 prior to mechanical refining; Lignosulfonates from Alkaline Sulfite—Anthraquinone Pulping (water-soluble lignin obtained by reacting woody material with sodium sulfite and a catalytic amount of anthraquinone at pH 9-13 and 160-180° C.); Organosolv Lignin (water-insoluble lignin or water-soluble sulfonated lignin obtained from an organic solvent-based system); Steam Explosion Lignin (water-insoluble lignin obtained by separating woody material into fibers through high temperature/high pressure treatment with steam.

The present invention, in some variations, is premised on the discovery that lignin separation may be improved, to a surprising extent, by introducing certain additives directly or indirectly into the hydrolysis or pretreatment reactor, as a precursor to later lignin separation by (for example) sedimentation, centrifugation, or filtration, or other separation operations to increase the lignin separation efficiency.

In some embodiments, the invention provides a method of improving lignin separation during lignocellulosic biorefining, the method comprising the steps of (i) catalyzing fractionation or hydrolysis with an acid to release sugars into an acidified solution containing lignin, (ii) neutralizing the acidified solution with a base to form a salt in a neutralized solution; (iii) in a separation unit, separating the salt and the lignin, each in free or combined form, from the neutralized solution; and then (iv) recycling a portion of the salt and optionally a portion of the lignin to step (i) to combine, physically or chemically, with the lignin, to improve lignin separation in the separation unit.

The salt may be selected from the group consisting of metal sulfates, metal sulfate hydrates, metal sulfate derivatives, ammonium sulfate, ammonium sulfate derivatives, and combinations thereof In some embodiments, the salt is selected from the group consisting of anhydrite, calcium sulfate hemihydrate, calcium sulfate dihydrate (gypsum), and combinations thereof In certain embodiments, the salt comprises or is gypsum.

Thus in some particular embodiments of the invention, a method of improving lignin separation during lignocellulosic biorefining, comprises the steps of (i) catalyzing fractionation or hydrolysis with a sulfur-containing acid and/or sulfur dioxide to release sugars and lignin into an acidified solution, (ii) neutralizing the acidified solution with lime to form gypsum in a neutralized solution; (iii) in a separation unit, separating the gypsum and the lignin, individually or in combination, from the neutralized solution; and then (iv) recycling a portion of the gypsum and optionally a portion of the lignin to step (i) to combine, physically or chemically, with the lignin released in step (i), to improve lignin separation in the separation unit in step (iii).

Certain exemplary embodiments of the invention will now be described. These embodiments are not intended to limit the scope of the invention as claimed. The order of steps may be varied, some steps may be omitted, and/or other steps may be added. Reference herein to first step, second step, etc. is for illustration purposes only.

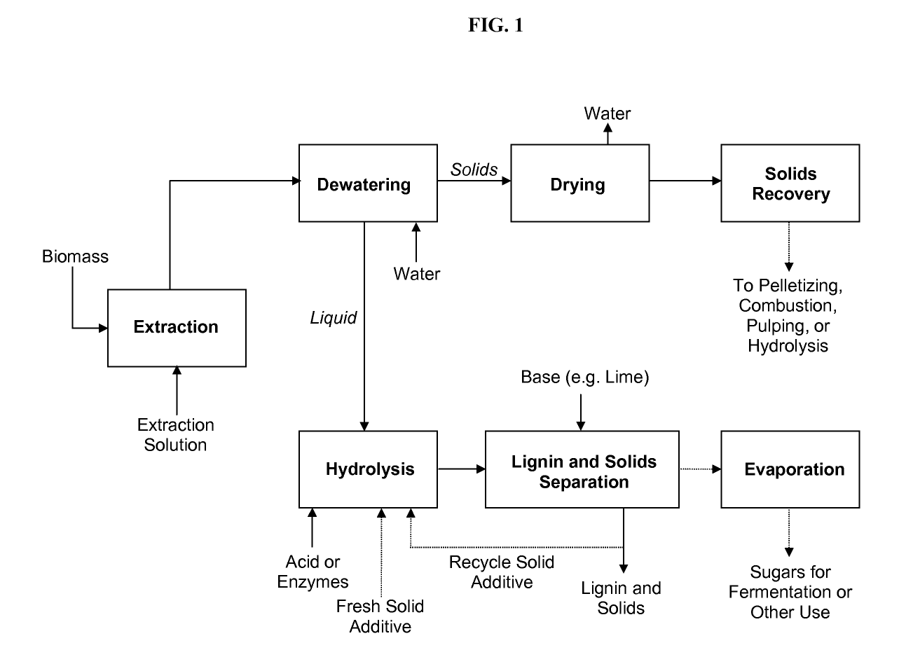

Some embodiments can be understood with reference to FIG. 1. When a process sequence includes a hydrolysis reactor followed by a separation unit for removing lignin, such as depicted in FIG. 1, it is preferable in some embodiments to minimize precipitation of lignin in the hydrolysis reactor itself. In other embodiments, the hydrolysis reactor is simultaneously or sequentially a separation device, or the hydrolysis reactor is a batch reactor and then batch separator. The dotted lines in FIG. 1 are optional streams.

In some embodiments, a process for producing fermentable hemicellulose sugars from lignocellulosic biomass comprises:
(a) providing a feedstock comprising lignocellulosic biomass;
(b) in an extraction unit, extracting the feedstock under effective extraction conditions to produce an extract liquor containing hemicellulosic oligomers, cellulose-rich solids, and lignin;
(c) substantially removing the cellulose-rich solids from the extract liquor;
(d) in a hydrolysis reactor, hydrolyzing the hemicellulosic oligomers contained in the extract liquor, in the presence of a hydrolysis catalyst, to produce fermentable hemicellulosic sugars;
(e) introducing a solid additive to the hydrolysis reactor, wherein the solid additive combines with at least a portion of the lignin;
(f) separating a mixture comprising the lignin and the solid additive, each in free or combined form, from the fermentable hemicellulosic sugars; and
(g) recovering the fermentable hemicellulosic sugars.

Effective extraction conditions may include contacting the lignocellulosic biomass with steam (at various pressures in saturated, superheated, or supersaturated form) and/or hot water. The hydrolysis catalyst may be an acid catalyst, a base catalyst, or an enzymatic catalyst. Preferably, the hydrolysis catalyst is an acid catalyst such as one selected from the group consisting of sulfuric acid, sulfurous acid, sulfur dioxide, and combinations thereof In some embodiments, the process is a variation of the Green Power+™ process technology which is commonly owned with the assignee of this patent application.

In some embodiments, the solid additive has a density that is higher than the density of lignin, that is, higher than about 1-1.5 g/cm³. For example the solid additive may have a density of about 1.1, 1.2, 1.3, 1.4, 1.5, 1.6, 1.7, 1.8, 1.9, 2.0, 2.1, 2.2, 2.3, 2.4, 2.5 g/cm³ or higher.

The solid additive may be introduced to the hydrolysis reactor as a dry powder, a wet powder, a slurry, partially or completely dissolved in a solution, as an aqueous liquid, in ionic form (i.e. a salt that is dissociated as anions and cations), etc. The term “solid additive” is meant to refer to the phase of the additive in isolation from the hydrolysis reactor or solution. Within the hydrolysis reactor itself, the additive is by no means limited to being a distinct solid phase.

In some embodiments, the solid additive contains sulfur, such as in the form of a sulfate salt. When the solid additive contains sulfur, it is possible for that sulfur to be reactive with the lignin so that at least a portion of the sulfur reacts with lignin to generate sulfonated lignin. Sulfonated lignin may be advantageous for downstream separation efficiency, in some embodiments.

Many solid additives are possible in the present invention. The solid additive may be selected from the group consisting of metal sulfates, metal sulfate hydrates, metal sulfate derivatives, ammonium sulfate, ammonium sulfate derivatives, native lignin, acid-condensed lignin, sulfonated lignin, lignin derivatives, and combinations thereof In some embodiments, the solid additive is selected from the group consisting of anhydrite (anhydrous calcium sulfate), calcium sulfate hemihydrate, calcium sulfate dihydrate (gypsum), and combinations thereof

In certain embodiments, the solid additive comprises gypsum. The solid additive may consist essentially of gypsum. In certain embodiments, especially those employing internal process recycling, the solid additive comprises gypsum and lignin. The solid additive may consist essentially of gypsum and lignin. When the solid additive is gypsum (or includes gypsum), that gypsum may include, or consist entirely of, recycled gypsum that is generated following the step(s) of separating the gypsum and lignin and from the fermentable hemicellulosic sugars. When the solid additive includes lignin, that lignin may include, or consist entirely of, recycled lignin that is generated following the step(s) of separating the gypsum and lignin from the fermentable hemicellulosic sugars.

When a base other than lime is used to neutralize the sugar solution from acid hydrolysis, then the solid additive may preferably be something other than gypsum. For example, when ammonia or an ammonium alkali is used as the neutralizing base, and ammonium sulfate is produced, when a preferred solid additive is ammonium sulfate.

In some embodiments, the solid additive is not introduced directly but rather generated in situ, such as by introducing a base to react a portion of the catalyst with the base to form the additive. For example lime could be introduced, wherein the lime reacts with some acid to form gypsum as the solid additive. It would also be possible to add two or components that react with each other (not with the catalyst) in situ to make the solid additive.

Other solid additives are possible in the present invention as well. For example, in some embodiments the solid additive is selected from the group consisting of minerals, diatomaceous earth, silica, alumina, ash, zeolites, activated carbon, metal alums, ammonium alum, dust, cellulose, nanocellulose, sawdust, agricultural residue pith, biomass fines, and combinations thereof

A mineral is a naturally occurring solid chemical substance formed through biogeochemical processes, having characteristic chemical composition and highly ordered atomic structure. Any of the more than 4,000 known minerals, according to the International Mineralogical Association, may be utilized as the solid additive in this invention. Zeolites include any known natural or synthetic zeolites, which are microporous, aluminosilicate minerals. Examples include, but are not limited to, talc, dolomite , olivine, and perlite.

Alums include any alums of general formula AM(SO₄)₂·nH₂O, where A is an alkali metal or ammonium, M is a trivalent metal, and n is greater than 1, such as from 6 to 20, e.g. 12. Exemplary alums include aluminum potassium sulfate (“potash alum” or simply “alum”), KAl(SO₄)₂·12H₂O; soda alum, NaAl(SO₄)₂·12H₂O; ammonium alum, NH₄Al(SO₄)₂·12H₂O; and chrome alum, KCr(SO₄)₂·12H₂O.

Other solid additives include cellulose of various origins and particle size, including nanocellulose, or cellulosic materials such as sawdust, agricultural residue pith (such as corn stover pith), or other biomass particles or particles derived from biomass.

In addition to the solid additive, in some embodiments another material is introduced, such as a buffer, an emulsifier, a mixing agent, or flocculating agent. For example, polymer flocculating agents may be introduced. Polymers can flocculate colloidal suspensions generally through the mechanisms of charge neutralization, formation of patches of opposite charge and subsequent attraction, and bridging. Flocculation depends on the size of the polymer molecule both in solution and after adsorption, charge density, polymer concentration, presence of other electrolytes, and the mode of addition. In some embodiments, the selected solid additive performs one or more of these functions to some extent. For instance, alum may act as a buffering agent as well as a flocculating agent.

In some embodiments, at least a portion of the solid additive combines, chemically or physically, with the lignin to form a lignin—additive complex that has one or more of the following properties, compared to the lignin: a higher density; a higher viscosity; a higher density/viscosity ratio; a higher settling rate; and/or reduced tackiness. The solid additive may be classified as a lignin detackifier, in some embodiments. Other rheological modification may be accomplished, to alter the physical or mechanical properties of the complex, compared to lignin alone.

The solid additive may be present in the hydrolysis reactor at a concentration of at least 0.1 g/L, at least 1 g/L, or at least 10 g/L, such as about 0.2, 0.5, 0.8, 1.0, 1.5, 2.0, 3.0, 4.0, 5.0, 6.0, 7.0, 8.0, 9.0, 10, 11, 12, 15, 20 g/L or higher.

In some embodiments, step (e) is performed prior to step (d). That is, the hydrolysis catalyst may be added and then the solid additive added to the reactor. Or, the solid additive may be added and then the hydrolysis catalyst added to the reactor. Or, these components may be simultaneously introduced.

The process may further comprise recovering and recycling at least a portion of the hydrolysis catalyst, at least a portion of the solid additive, or both.

The lignin—additive complex may be separated from solution using a variety of separation devices. The separation unit may be selected from filters, membranes, decanters, clarifiers, centrifuges, decanting centrifuges, cyclones, hydrocyclones, precipitators, electrostatic precipitators, evaporators, flash vessels, distillation columns, and so on. The lignin—additive complex may be recovered in solid form, in slurry form, or as a dilute solution in liquid.

The lignin and additive may be recovered in combination, or they may be recovered separately, in one or multiple stages or units. When the lignin and additive are recovered together, a portion may be recycled back to the hydrolysis reactor (at least some should be purged at steady state to avoid lignin build-up). When the lignin and additive are recovered separately, it is possible to recycle all of the additive and some of the lignin, all of the additive and none of the lignin, some of each of the additive and lignin, etc.

The remainder of the process, in some variations, will now be described without limiting the principles of the invention.

The biomass feedstock may be selected from hardwoods, softwoods, forest residues, agricultural residues (such as sugarcane bagasse), industrial wastes, consumer wastes, or combinations thereof

In some embodiments, such as the process depicted in FIG. 1, the process starts as biomass is received or reduced to approximately ¼″ thickness. In a first step of the process, the biomass chips are fed to a pressurized extraction vessel operating continuously or in batch mode. The chips may be steamed or water-washed to remove dirt and entrained air. The chips are immersed with aqueous liquor or saturated vapor and heated to a temperature between about 100° C. to about 250° C., for example 150° C., 160° C., 170° C., 180° C., 190° C., 200° C., or 210° C. Preferably, the chips are heated to about 180° C. to 210° C. The pressure in the pressurized vessel may be adjusted to maintain the aqueous liquor as a liquid, a vapor, or a combination thereof. Exemplary pressures are about 1 atm to about 30 atm, such as about 3 atm, 5 atm, 10 atm, or 15 atm.

The aqueous liquor may contain acidifying compounds, such as (but not limited to) sulfuric acid, sulfurous acid, sulfur dioxide, acetic acid, formic acid, or oxalic acid, or combinations thereof The dilute acid concentration can range from 0 to 10% as necessary to improve solubility of particular minerals, such as potassium, sodium, or silica. In some embodiments, the aqueous liquor is steam or hot water.

A second step may include depressurization of the extracted chips. The vapor can be used for heating the incoming woodchips or cooking liquor, directly or indirectly. The volatilized organic acids (e.g., acetic acid), which are generated or included in the cooking step, may be recycled back to the cooking.

A third step may include washing the extracted chips. The washing may be accomplished with water, recycled condensates, recycled permeate, or combination thereof. A liquid biomass extract is produced. A countercurrent configuration may be used to maximize the biomass extract concentration. Washing typically removes most of the dissolved material, including hemicelluloses and minerals. The final consistency of the dewatered cellulose-rich solids may be increased to 30% or more, preferably to 50% or more, using a mechanical pressing device.

The third step, or an additional step prior to drying (below), may include further hydrolyzing the extracted chips with enzymes or an acid to extract some of the cellulose as fermentable glucose. The removal of cellulose increases the heating value of the remaining lignin-rich solids. In certain embodiments, the heating value of the remaining solids can approach that of lignin, i.e. in the range of about 10,000 to 12,000 Btu/lb. In some preferred embodiments, the additional hydrolysis is mild hydrolysis that leaves a substantial portion of cellulose in the extracted solids. The mild hydrolysis can take advantage of the initial extraction (first step) of most or all of the hemicellulosic material, leaving a somewhat hollow structure. The hollow structure can increase the effectiveness of cellulose hydrolysis, such as by reducing mass-transfer limitations of enzymes or acids in solution.

When enzymes are employed for the cellulose hydrolysis, the enzymes are preferably cellulase enzymes. Enzymes may be introduced to the extracted chips along with the wash solution, e.g. water, recycled condensates, recycled permeate, or combinations thereof Alternatively, or additionally, enzymatic hydrolysis may be carried out following washing and removal of hemicelluloses, minerals, and other soluble material.

Enzymes may be added to the extracted chips before or after mechanical pressing. That is, enzymatic hydrolysis may be carried out and then the solids pressed to final consistency; or, the solids may be pressed to high consistency (e.g., 30% or more) and then enzymes introduced to carry out cellulose hydrolysis. It may be beneficial to conduct refining or milling of the dewatered cellulose-rich solids prior to the enzymatic hydrolysis.

The enzymatic hydrolysis may be achieved in a separate unit, such as between washing and drying, or as an integrated part of washing. In some embodiments, at least a portion of enzymes are recycled in a batch or continuous process.

When an acid is employed for the cellulose hydrolysis, the acid may be selected from sulfuric acid, sulfurous acid, sulfur dioxide, formic acid, acetic acid, oxalic acid, or combinations thereof Dilute-acid hydrolysis is preferred, to avoid sugar degradation. Acids may be introduced to the extracted chips along with the wash solution, e.g. water, recycled condensates, recycled permeate, or combinations thereof Alternatively, or additionally, acid hydrolysis may be carried out following washing and removal of hemicelluloses, minerals, and other soluble material.

Acids may be added to the extracted chips before or after mechanical pressing. That is, acid hydrolysis may be carried out and then the solids pressed to final consistency; or, the solids may be pressed to high consistency (e.g., 30% or more) and then acids introduced to carry out cellulose hydrolysis. It may be beneficial to conduct refining or milling of the dewatered cellulose-rich solids prior to the acid hydrolysis.

The acid hydrolysis may be achieved in a separate unit, such as between washing and drying, or as an integrated part of washing. A solid additive is introduced to this unit, as described above. The solid additive may include some or all recycled material in a batch or continuous process. In some embodiments, at least a portion of the acid is also recycled in a batch or continuous process.

A fourth step may include drying of the extracted material to a desired final moisture. The heat necessary for drying may be derived from combusting part of the starting biomass. Alternatively, or additionally, the heat for drying may be provided by other means, such as a natural gas boiler or other auxiliary fossil fuel, or from a waste heat source.

A fifth step may include preparing the biomass for combustion. This step may include refining, milling, fluidizing, compacting, and/or pelletizing the dried, extracted biomass. The biomass may be fed to a boiler in the form of fine powder, loose fiber, pellets, briquettes, extrudates, or any other suitable form. In some embodiments, pellets of extracted biomass are preferred. Using known equipment, biomass may be extruded through a pressurized chamber to form uniformly sized pellets or briquettes.

The energy-dense biomass will generally have higher energy density compared to a process that does not extract hemicellulosic sugars from the feedstock prior to combustion. Depleting the biomass of both hemicellulose and cellulose enriches the remaining material in lignin, which has a higher energy density than hemicellulose or cellulose.

In some embodiments, the energy density of the biomass pellet is similar to the energy density of a torrefied pellet derived from wood. For example, the biomass pellets may have an energy content from about 8,500 Btu/lb to about 12,000 Btu/lb on a dry basis, such as at least 9,000 Btu/lb or at least 10,000 Btu/lb on a dry basis.

A sixth step is combustion of the biomass, which in some embodiments is in the form of biomass pellets. The biomass pellets are fed to a boiler and combusted, preferably with excess air, using well-known combustion apparatus. Boiler bottom may be fixed, moving, or fluidized for the best efficiency. The flue gas is cooled and fly ash is collected into gravity collectors.

The energy-dense biomass has lower inorganic emissions potential compared to the original cellulosic biomass, in preferred embodiments. The reason is that the energy-dense biomass will contain lower ash content compared to a process that does not extract inorganic components from the feedstock prior to combustion, in the manner disclosed herein. In some embodiments, the extracted biomass is sufficiently low in ash such that when the extracted biomass is combusted, particulate matter emissions are very low. In certain embodiments, the particulate matter emissions are so low as to avoid the need for any additional cleaning device, and associated control system, in order to meet current emission regulations.

A seventh step may include treatment of the biomass extract to form a hydrolysate comprising fermentable hemicellulose sugars. In some embodiments, the biomass extract is hydrolyzed using dilute acidic conditions at temperatures between about 100° C. and 190° C., for example about 120° C., 130° C., 140° C., 150° C., 160° C., or 170° C., and preferably from 120° C. to 150° C.

The acid may be selected from sulfuric acid, sulfurous acid, or sulfur dioxide. Alternatively, or additionally, the acid may include formic acid, acetic acid, or oxalic acid from the cooking liquor or recycled from previous hydrolysis. Alternatively, hemicellulase enzymes may used instead of acid hydrolysis. The lignin from this step may be separated and recovered, or recycled, or sent directly to the boiler.

An eighth step may include evaporation of hydrolysate to remove some or most of the volatile acids. The evaporation may include flashing or stripping to remove sulfur dioxide, if present, prior to removal of volatile acids. The evaporation step is preferably performed below the acetic acid dissociation pH of 4.8, and most preferably a pH selected from about 1 to about 2.5. The dissolved solids are concentrated, such as to about 10% to about 40% to optimize fermentable hemicellulose sugar concentration to a particular microorganism. Saccharomyces Cerevisiae fermentation can withstand dissolved solids concentrations of 30-50%, while Clostridia Acetobutylicum fermentation is viable at 10-20% concentrations only, for example.

In some embodiments, additional evaporation steps may be employed. These additional evaporation steps may be conducted at different conditions (e.g., temperature, pressure, and pH) relative to the first evaporation step.

In some embodiments, some or all of the organic acids evaporated may be recycled, as vapor or condensate, to the first step (cooking step) and/or third step (washing step) to remove assist in the removal of minerals from the biomass. This recycle of organic acids, such as acetic acid, may be optimized along with process conditions that may vary depending on the amount recycled, to improve the cooking and/or washing effectiveness.

Some embodiments of the invention enable processing of “agricultural residues,” which for present purposes is meant to include lignocellulosic biomass associated with food crops, annual grasses, energy crops, or other annually renewable feedstocks. Exemplary agricultural residues include, but are not limited to, corn stover, corn fiber, wheat straw, sugarcane bagasse, rice straw, oat straw, barley straw, miscanthus, energy cane, or combinations thereof. In certain embodiments, the agricultural residue is sugarcane bagasse.

In some embodiments, the fermentable hemicellulose sugars are recovered from solution, in purified form. In some embodiments, the fermentable hemicellulose sugars are fermented to produce of biochemicals or biofuels such as (but by no means limited to) ethanol, 1-butanol, isobutanol, acetic acid, lactic acid, or any other fermentation products. A purified fermentation product may be produced by distilling the fermentation product, which will also generate a distillation bottoms stream containing residual solids. A bottoms evaporation stage may be used, to produce residual solids.

Following fermentation, residual solids (such as distillation bottoms) may be recovered, or burned in solid or slurry form, or recycled to be combined into the biomass pellets. Use of the fermentation residual solids may require further removal of minerals. Generally, any leftover solids may be used for burning as additional liquefied biomass, after concentration of the distillation bottoms.

Part or all of the residual solids may be co-combusted with the energy-dense biomass, if desired. Alternatively, or additionally, the process may include recovering the residual solids as a fermentation co-product in solid, liquid, or slurry form. The fermentation co-product may be used as a fertilizer or fertilizer component, since it will typically be rich in potassium, nitrogen, and/or phosphorous.

Optionally, the process may include co-combusting the recovered lignin with the energy-dense biomass, to produce power. The recovered lignin may be combined with the energy-dense biomass prior to combustion, or they may be co-fired as separate streams. When recovered lignin is combined with the energy-dense biomass for making pellets, the lignin can act as a pellet binder.

Part or all of the residual solids may be co-combusted with the energy-dense biomass, if desired. Alternatively, or additionally, the process may include recovering the residual solids as a fermentation co-product in solid, liquid, or slurry form. The fermentation co-product may be used as a fertilizer or fertilizer component, since it will typically be rich in potassium, nitrogen, and/or phosphorous.

In certain embodiments, the process further comprises combining, at a pH of about 4.8 to 10 or higher, a portion of the vaporized acetic acid with an alkali oxide, alkali hydroxide, alkali carbonate, and/or alkali bicarbonate, wherein the alkali is selected from the group consisting of potassium, sodium, magnesium, calcium, and combinations thereof, to convert the portion of the vaporized acetic acid to an alkaline acetate. The alkaline acetate may be recovered. If desired, purified acetic acid may be generated from the alkaline acetate.

In this detailed description, reference has been made to multiple embodiments of the invention and non-limiting examples relating to how the invention can be understood and practiced. Other embodiments that do not provide all of the features and advantages set forth herein may be utilized, without departing from the spirit and scope of the present invention. This invention incorporates routine experimentation and optimization of the methods and systems described herein. Such modifications and variations are considered to be within the scope of the invention defined by the claims.

All publications, patents, and patent applications cited in this specification are herein incorporated by reference in their entirety as if each publication, patent, or patent application were specifically and individually put forth herein.

Where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially.

Therefore, to the extent there are variations of the invention, which are within the spirit of the disclosure or equivalent to the inventions found in the appended claims, it is the intent that this patent will cover those variations as well. The present invention shall only be limited by what is claimed.

What is claimed is:

1. A process for producing fermentable hemicellulose sugars from lignocellulosic biomass, said process comprising:
(a) providing a feedstock comprising lignocellulosic biomass;
(b) in an extraction unit, extracting said feedstock under effective extraction conditions to produce an extract liquor containing hemicellulosic oligomers, cellulose-rich solids, and lignin;
(c) substantially removing said cellulose-rich solids from said extract liquor;
(d) in a hydrolysis reactor, hydrolyzing said hemicellulosic oligomers contained in said extract liquor, in the presence of a hydrolysis catalyst, to produce fermentable hemicellulosic sugars;
(e) introducing a solid additive to said hydrolysis reactor, wherein said solid additive combines with at least a portion of said lignin;
(f) separating a mixture comprising said lignin and said solid additive, each in free or combined form, from said fermentable hemicellulosic sugars; and
(g) recovering said fermentable hemicellulosic sugars.

2. The process of claim 1, wherein said effective extraction conditions include contacting said lignocellulosic biomass with steam and/or hot water.

3. The process of claim 1, wherein said hydrolysis catalyst is an acid catalyst.

4. The process of claim 1, wherein said hydrolysis catalyst is selected from the group consisting of sulfuric acid, sulfurous acid, sulfur dioxide, and combinations thereof

5. The process of claim 1, wherein said solid additive is selected from the group consisting of metal sulfates, metal sulfate hydrates, metal sulfate derivatives, ammonium sulfate, ammonium sulfate derivatives, native lignin, acid-condensed lignin, sulfonated lignin, lignin derivatives, and combinations thereof

6. The process of claim 5, wherein said solid additive is selected from the group consisting of anhydrite, calcium sulfate hemihydrate, calcium sulfate dihydrate (gypsum), and combinations thereof

7. The process of claim 6, wherein said solid additive comprises gypsum.

8. The process of claim 6, wherein said solid additive consists essentially of gypsum.

9. The process of claim 5, wherein said solid additive comprises gypsum and lignin.

10. The process of claim 5, wherein said solid additive consists essentially of gypsum and lignin.

11. The process of claim 1, wherein said solid additive is selected from the group consisting of minerals, diatomaceous earth, silica, alumina, ash, zeolites, activated carbon, metal alums, ammonium alum, dust, cellulose, nanocellulose, sawdust, agricultural residue pith, biomass fines, and combinations thereof

12. The process of claim 1, wherein at least a portion of said solid additive combines, chemically or physically, with said lignin to form a lignin—additive complex that has a higher settling rate than that of said lignin.

13. The process of claim 1, wherein at least a portion of said solid additive combines, chemically or physically, with said lignin to form a lignin—additive complex that has reduced tackiness compared to said lignin.

14. The process of claim 1, wherein said solid additive contains sulfur, and wherein at least a portion of said sulfur reacts with said lignin to generate sulfonated lignin.

15. A process for producing fermentable hemicellulose sugars from lignocellulosic biomass, said process comprising:
(a) providing a feedstock comprising lignocellulosic biomass;
(b) in an extraction unit, extracting said feedstock under effective extraction conditions with steam or hot water to produce an extract liquor containing hemicellulosic oligomers, cellulose-rich solids, and lignin;
(c) substantially removing said cellulose-rich solids from said extract liquor;
(d) in a hydrolysis reactor, hydrolyzing said hemicellulosic oligomers contained in said extract liquor, in the presence of an acid hydrolysis catalyst, to produce fermentable hemicellulosic sugars;
(e) introducing gypsum to said hydrolysis reactor or forming gypsum in situ inside said hydrolysis reactor, wherein said gypsum combines with at least a portion of said lignin;
(f) separating a mixture comprising said lignin and said gypsum, each in free or combined form, from said fermentable hemicellulosic sugars;
(g) neutralizing an acidic solution of said fermentable hemicellulosic sugars with lime, thereby generating produced gypsum;
(h) recovering said fermentable hemicellulosic sugars; and
(i) recycling at least a portion of said produced gypsum to step (e).

16. A method of improving lignin separation during lignocellulosic biorefining, said method comprising the steps of (i) catalyzing fractionation or hydrolysis with an acid to release sugars into an acidified solution containing lignin, (ii) neutralizing said acidified solution with a base to form a salt in a neutralized solution; (iii) in a separation unit, separating said salt and said lignin, each in free or combined form, from said neutralized solution; and then (iv) recycling a portion of said salt and optionally a portion of said lignin to step (i) to combine, physically or chemically, with said lignin, to improve lignin separation in said separation unit.

17. The method of claim 16, wherein said separation unit is selected from the group consisting of a filter, a membrane, a decanter, a clarifier, a hydrocyclone, and a centrifuge.

18. The method of claim 16, wherein said salt is selected from the group consisting of metal sulfates, metal sulfate hydrates, metal sulfate derivatives, ammonium sulfate, ammonium sulfate derivatives, and combinations thereof

19. The method of claim 18, wherein said salt is selected from the group consisting of anhydrite, calcium sulfate hemihydrate, calcium sulfate dihydrate (gypsum), and combinations thereof

20. The method of claim 19, wherein said salt comprises gypsum.
